(19) United States
(12) Patent Application Publication
(10) Pub. No.: US 2007/0038944 A1
(43) Pub. Date: Feb. 15, 2007

(54) Augmented reality system with real marker object identification

(75) Inventors: Andrea Carignano, Torino (IT); Simona Martini, Torino (IT)

Correspondence Address: SEED INTELLECTUAL PROPERTY LAW GROUP PLLC, 701 FIFTH AVE, SUITE 5400, SEATTLE, WA, 98104, US

(73) Assignee: Seac02 S.r.I., Torino (IT)

(21) Appl. No.: 11/416,792

(22) Filed: May 3, 2006

(30) Foreign Application Priority Data
May 3, 2005 (EP) 05009717.9

(51) Int. Cl. G06F 3/00

(52) U.S. Cl. 715/757

(57) ABSTRACT

An augmented reality system comprises means for gathering image data of a real environment, means for generating virtual image data from said image data, means for identifying a predefined marker object of the real environment based on the image data, and means for superimposing a set of object image data with the virtual image data at a virtual image position corresponding to the predefined marker object.

### TECHNICAL FIELD

Generally, the present disclosure relates to an augmented reality system and related methods, and, more particularly, to methods and a system that is configured to survey a real world environment, generate image data thereof, render virtual image data and superimpose the virtual image data with additional object data so as to “augment” the real world environment.

### BACKGROUND

The rapid advance in computer technology has brought about significant improvements in various technical fields, such as image processing, software development, and the like. Consequently, even small sized computer devices provide the computational power and resources for manipulating image data in real time, thereby offering the potential for many technical developments usable in everyday applications. One important example is the so-called augmented reality technology, in which a real environment is surveyed so as to generate image data thereof, while the image data received from the real environment may be processed and manipulated and may thereby be supplemented by object image data from a “virtual” object so as to provide an image to the user including the virtual object. Moreover, the user's perception of the real environment may be augmented with any kind of information as may be needed for the application under consideration. Typically, an augmented reality system comprises an imaging system, such as a video camera, so as to generate image data of the real environment, which is then combined with any computer-generated graphics or other information that is then provided to the user so as to place the user in an augmented environment. For instance, if a user intends to design a living room or a kitchen in his house, the corresponding room, possibly including some furniture, may represent the real environment imaged by the video camera, whereas the augmented reality presented to the user on an appropriate display device may include additional furniture created by the computer on the basis of an appropriate database. For this purpose, typically specific positions in the imaged real environment may be marked by a corresponding cursor or the like, and one of the objects of the database selected by the user may be inserted into the image while observing the spatial relationships of the virtual object with respect to the “real” objects. Although these conventional augmented reality systems provide inexpensive alternatives in, for instance, designing rooms, houses and the like, they nevertheless lack flexibility in positioning the virtual objects within the real environment when, for instance, a high degree of variation of the viewer position with respect to the position of the virtual object is desired.

Therefore, a need exists for an augmented reality system and a method that allows enhanced flexibility and improved “fidelity” in tracking and superimposing virtual objects with a specified real environment.

### BRIEF DESCRIPTION OF THE SEVERAL VIEWS OF THE DRAWING(S)

Further preferred embodiments of the present invention are defined in the appended claims and will also be described in the following with reference to the accompanying drawings.

FIG. 1a schematically shows an augmented reality system in accordance with the present description.

FIG. 1b schematically shows additional components, such as a tracking system, a distance measurement system and a rendering system of the embodiment of FIG. 1a.

FIG. 1c schematically shows the operating principle of the rendering system shown in FIG. 1b.

FIG. 1d depicts a flow chart for illustrating the operation of the rendering system.

FIG. 2 schematically depicts an embodiment including a head-mounted display device in accordance with one illustrative embodiment.

FIG. 3 schematically shows a virtual mirror system according to one illustrative embodiment of the present description.

### DETAILED DESCRIPTION

According to one aspect of the present description, enhanced flexibility and improved “fidelity” in tracking and superimposing virtual objects with a specified real environment is provided by an augmented reality system comprising means for gathering image data of a real environment, means for generating virtual image data from the image data, means for identifying a predefined marker object of the real environment based on the image data and, finally, a means for superimposing a set of object image data with the virtual image data at a virtual image position corresponding to the predefined marker object.

Consequently, according to the enhanced augmented reality system the predefined marker object, which may be placed anywhere in the real environment, is identified in an automated fashion based on the image data corresponding to the real environment, thereby allowing a high degree of flexibility in, for instance, “viewing” the virtual object from any desired point of view. Contrary to conventional augmented reality systems, in which the position of a virtual object is typically selected on the basis of the image of the real environment, the present technique enables to “observe” the virtual object already in the real environment by correspondingly viewing it's place holder, ie. the marker object. Consequently, various viewing angles and viewpoints may be selected, thereby generating detailed information about the spatial relationship of the virtual object to real object in the environment, which may assist in a more real embedding of the virtual object into the neighbourhood of the real environment. For example, the marker object may frequently be re-positioned in the environment, wherein the image data generated from the reconfigured real environment may allow to more precisely take into consideration the illumination conditions, particularly when the point of view is also changed. For instance, a user walking through a room may continuously point to the marker object, thereby generating the virtual image data which may then represent the room with a plurality of information about the real conditions for a plurality of different view points of the virtual object. Thus, embedding of the virtual object may be accomplished in a more realistic manner.

In a further preferred embodiment, means are provided for correlating a plurality of sets of object data with the predefined marker object. Hence, the same marker object in the real environment may be associated with a plurality of virtual objects so that, upon user selection, a specific one of the virtual objects may be selected so as to replace the marker object in the virtual reality. It should be appreciated that the plurality of sets of object image data may be generated upon request from appropriate data, which may be stored in advance or which may be generated upon request. For example, the data representing a virtual object may have been obtained by image data of a different real environment, which may be processed and manipulated so as to enable the creation of three-dimensional image data according to a specified spatial orientation of the virtual object as required during the embedding of the virtual object into the image data of the real environment. Similarly, data for creating the object image data may also be obtained from the real environment under consideration, for instance by isolating a portion of the image data and correspondingly processing the data in any appropriate fashion to thereby provide the object image data when required. In other embodiments, the object image data may represent data created entirely by software resources or at least partially by software tools, such as design software, and the like.

In a further preferred embodiment, means are provided for selecting one of the plurality of sets of object image data that are to be superimposed with the virtual image data. Thus, while in some applications the correlation between the sets of object image data and the marker object may be predefined by the system, for instance each of the sets of object image data may be used in generating the augmented reality in a timely predefined sequence, in this embodiment, the respective association of the object image data with the marker object may be selected by the user.

In one illustrative embodiment, the means for selecting a correlation comprises a speech recognition system, to enable a convenient selection of one of plural virtual objects to be embedded into the real environment.

In a further preferred embodiment, the system further comprises output means for displaying at least the virtual image data. Consequently, the virtual image data may be displayed to the user, preferably in real time, thereby allowing to substantially instantly provide an augmented real environment to the user, wherein different viewpoints and various virtual objects, depending on the number of sets of object image data, may be realised.

In other embodiments, the output means is furthermore configured to present in addition to the virtual image data other information, such as audio information, tactile information, olfactory information, and the like. For example, in simulating any panic situations, it may be appropriate to not only include any visible virtual objects into the real environment, but also audio and olfactory “objects”, which of course may not be considered as virtual objects.

In a further preferred embodiment, the output means comprises a head-mounted display means. For instance, the head-mounted display means may be provided in the form of eyeglasses, having appropriate display surfaces instead of lenses, such as LCD display means, so as to provide a highly real three-dimensional impression of the augmented reality. The head-mounted display means may also comprise corresponding means for providing audio data and/or olfactory “data”, for instance in the form of gaseous components, and the like.

In a further preferred embodiment, the head-mounted display means comprises means for gathering image data of the real environment. Thus, the user wearing the head-mounted display means may “see” the real environment on the basis of the virtual image data gathered by, for instance, appropriately positioned cameras and the like, while the marker object may be replaced by a specified set of object image data. Consequently, highly authentic three-dimensional image data may be obtained from the real environment, for instance by replacing corresponding image elements at positions that substantially correspond to the positions of the user's eyes so that the marker object, which is replaced by the virtual object, may be viewed without actually being visible to the user, thereby creating a high degree of “reality” of the environment including the virtual object.

In a further preferred embodiment, the means for identifying a predefined marker object comprises a tracking system that is configured to determine relative position data and orientation data of the marker object with respect to the means for gathering image data of the real environment. Hence, the tracking system enables the determination of the spatial relationship of the point of view, ie. of a camera and the like, to the marker object so that the orientation and the position of the marker object and thus of the virtual object may continuously be updated in accordance with a motion of the point of view. Moreover, based on the relative position data and the orientation data the virtual object may appropriately be rescaled so as to take into consideration the relative distance between the point of view and the marker object. Furthermore, the tracking system may comprise a scaling system so as to adapt the general size of the virtual object to the objects of the real environment. To this end, a distance measurement system may be provided in the tracking system which is configured to determine one or more absolute values of distances of objects in the real environment on the basis of the image data. For example, if furniture is to represent virtual objects to be incorporated into a real environment, corresponding absolute dimensions of these virtual objects are typically available when accessing the virtual object. Based on these absolute dimensions and any absolute distances obtained from the tracking system, the virtual object may appropriately be rescaled and therefore incorporated into the real environment without undue size “distortions”.

Preferably, the tracking system is configured to provide and manipulate the relative position data and orientation data as well as any absolute distances substantially in real-time so as to allow a corresponding real-time manipulation of the object image data, thereby providing the augmented reality substantially in real-time. It should be understood that the term “real-time” refers to a processing time for data manipulation that allows a perception of the augmented reality substantially without any undue delay for a human viewer. For example, if moderately slow changes of the viewpoint of the real environment are performed, the corresponding augmented reality is provided substantially without a noticeable delay for human perception. As an example, using the above-identified head-mounted display means including one or more cameras for obtaining the image data of the real environment, the displayed augmented reality should substantially correspond to any movement of the user, such as a moderately slow turning of the head, walking through the environment, and the like.

Preferably, the system further comprises an object data generator for obtaining one or more sets of object image data. The object data generator may be based on image data of a “real” object to be used as virtual object and/or graphics tools for virtually generating at least portions of the virtual object and/or other information associated with the virtual object under consideration, such as sound data, olfactory data, and the like. For example, object-based software tools may be provided in the generator so as to provide the virtual object in real-time, wherein the outer appearance of the virtual object is adapted to the real environment image data by the tracking system in an appropriate manner, as is described above. In other examples, a real-time animation may be included so as to allow a variation of size and shape of the virtual object in accordance with a predefined process flow or in accordance with user selection. For instance, in simulating panic situations, such as fire in a building, the virtual object initially placed at a position described by the marker object may vary in size and shape and may even initiate the presence of further virtual objects at positions that may not be indicated by any marker objects so as to provide a substantially dynamic behaviour of the virtual object under consideration.

In other embodiments, the means for identifying a marker object may be configured so as to identify a plurality of marker objects, wherein each of the plurality of marker objects is correlated with one or more virtual objects. Consequently, a high degree of flexibility is provided as the real environment may readily be adapted by correspondingly replacing respective marker objects in the environment.

In a further preferred embodiment, the system further comprises a rendering system configured to operate on the set of object image data and the virtual image data so as to adapt the object image data to illumination conditions represented by the virtual image data. In order to obtain a high degree of “reality” even for the virtual object inserted into the real environment, the present technique enables an appropriate adaptation of the appearance of the virtual object with respect to the illumination conditions prevailing in the real environment. Typically, the virtual object is created independently from the image data of the real environment, wherein the size and orientation of the virtual objects are then appropriately adapted to the actual point of view and the position of the marker object. By means of the rendering system, the local illumination situation at the position of the marker object and in its neighbourhood may be taken into consideration when generating the image data for the virtual object. Hence, global or local brightness and colour variations due to the specific illumination condition of the real environment, especially at the position of the marker object, may be created upon the generation of the object image data.

Preferably, the rendering system is further configured to generate virtual shadow on the basis of the position of the marker object, the set of object image data and the illumination conditions of the real environment. Consequently, a highly realistic embedding of the virtual object into the real environment may be achieved. For example, even though the marker object may not represent an object that actually significantly affects the “real” illumination system at the position of the marker object, and may merely represent a substantially two-dimensional symbol, the rendering system may nevertheless estimate the virtual illumination situation for the augmented reality so as to generate appropriate virtual shadow that may be caused by the virtual object and/or that may be caused by the real objects on the virtual objects, or at least portions thereof.

In a further advantageous embodiment, the system comprises a virtual illumination system configured to determine at least a position and/or an intensity and/or a colour distribution of at least one real light source in the real environment on the basis of the image data gathered. Thus the virtual illumination system enables to quantitatively analyze the illumination situation in the real environment by identifying at least one light source and quantitatively characterizing at least some of its characteristics. For instance, when the real environment represents a room including one or more light bulbs, windows, etc, presently “active” light sources may be identified and the corresponding information may be used in appropriately implementing the virtual object into the real environment while taking into consideration the effect of the identified light source on the virtual object.

In a further embodiment, the virtual illumination system is further configured to generate a virtual light source corresponding to the at least one identified real light source. Consequently, the light source may be “integrated” into the virtual reality, thereby enabling a high degree of adaptation of the virtual object to the illumination condition provided by the virtual light source. Advantageously, the virtual illumination system is configured to vary the position and/or the intensity and/or the colour of the virtual light source. Thus, the real environment may be “observed” under illumination conditions that differ from the presently prevailing illumination situation, thereby enabling an assessment of the virtual object under varying and quite different environmental conditions. For example, the effect of jewellery, clothes etc, may be assessed under different light conditions. Preferably, the virtual illumination system is further configured to generate one or more additional virtual light sources so as to provide an enhanced flexibility in creating “virtual” illumination conditions or in more precisely simulating the presently prevailing illumination condition in the real environment. For example, the illumination condition of the real environment may not readily be simulated by one or few light sources, such as when a diffused illumination is considered, whereas the embedding of relatively large three-dimensional virtual objects may nevertheless considerably change the total illumination conditions. In other embodiments, the virtual object itself may be the source of light so that it may be considered to introduce one or more additional light sources into the real environment.

According to a further aspect, a virtual mirror system is provided that comprises an augmented reality system as is specified in the embodiments above or in the embodiments that will be described with reference to the accompanying figures. Moreover, the virtual mirror system comprises display means having a display surface positioned in front of a part of interest of the real environment, wherein the means for gathering image data of the real environment comprises and optical imaging system that is positioned in front of the part of interest.

Thus, the positioning of a display surface in combination with the positioning of the optical imaging system allows to obtain a mirror function of the system wherein, for instance, the user may represent the part of interest of the real environment, thereby allowing the user to obtain a view of himself/herself with the marker object being replaced by the corresponding virtual object. For instance, the marker object may represent virtual objects, such as jewellery, clothes, cosmetic articles, different hairstyles, and the like.

Preferably, the virtual mirror system is configured to identify a plurality of predefined marker objects provided in the part of interest. Hence, a plurality of virtual objects in various combinations may be assessed by the user. For instance, ear stickers may be viewed along with a necklace, or different parts of clothes may virtually be combined. Moreover, the effect of cosmetic or surgical operations may be assessed by the user in advance.

According to a further aspect, a method of generating an augmented reality is provided, wherein the method comprises gathering image data from a real environment and identifying a predefined marker object provided in the real environment on the basis of the image data. Moreover, virtual image data of the real environment are generated and at least virtual image data corresponding to the predefined marker object are replaced by object image data associated with the predefined marker object.

Hence the method may be used in combination with the above-described augmented reality system, thereby providing substantially the same advantages.

Preferably, the method further comprises tracking the predefined marker object when modified image data are gathered from the real environment. That is, the predefined marker object is “observed” even if changing image data are obtained from the real environment, thereby enabling an appropriate reconfiguration of the virtual object that replaces the marker object in the virtual image data.

In one illustrative embodiment, tracking the predefined marker object at least comprises determining a relative position and orientation of the predefined marker object with respect to a virtual reference point. Thus, by appropriately selecting a virtual reference point, such as the position of an optical imaging system such as a camera, and the like, which may move around in the real environment, the virtual object may be incorporated into the virtual image of the real environment with appropriate position, dimension and orientation. In other cases, the marker object may move around the environment, for instance to visualize the effect of moving objects within a specified environment, wherein the relative positional data and orientation with respect to the virtual reference point provides the possibility to appropriately scale, position and orient the virtual object in its virtual environment.

In other preferred embodiments, the object image data may be generated on the basis of image data from a second real environment that is different from the real environment, and/or on the basis of image data from the real environment and/or the basis of a virtual reality. As is already previously explained, a high degree of flexibility in generating virtual objects is presented in that data arising from a real object, ie. image data of a real object, may be used in combination with appropriate image processing tools so as to obtain corresponding three-dimensional data on which the tracking system may operate so as to provide for the required scaling, positioning and orienting activities required for a correct integration of the virtual object into the real environment image data. Moreover, the present technique also allows any combination of virtually-generated object data, for instance produced by appropriate software tools, such as design software or any other appropriate graphics tools, or wherein purely virtually-generated object data may be combined with data obtained by imaging real objects. Hereby, the generation of the object data may be performed at any appropriate time, depending on the computational resources of the corresponding augmented reality system. For example, one or more sets of object data may be stored in advance in a database, which may then be retrieved upon request. In other cases, one or more virtual objects may be created by software applications operated simultaneously with the augmented reality system, wherein the user may interactively communicate with the software application so as to influence the generation of the optic data, while in other cases the software application itself may determine, at least partially, specifics of the virtual object. For example, when simulating certain panic situations the software application may provide for virtual object data based on random and/or user interaction, and/or on the basis of a predefined process flow.

In a further advantageous embodiment, the method comprises scanning at least a portion of the real environment to generate scan data and determining an illumination condition of the real environment on the basis of the scan data. Scanning of the real environment, for instance by changing the observation angle within a range of 270° or even 360°, enables to establish an illumination map, which may be used to appropriately adapt the outer appearance of the virtual object under the given illumination condition. Preferably, scanning of the portion of the real environment is performed for at least two different illumination conditions. Consequently, a corresponding illumination map for the at least two different illumination conditions may be used to more precisely estimate the correct brightness and colouration of the virtual object. Moreover, based on the scan data, the augmented reality may be displayed to the user on the basis of different illumination conditions, which therefore provide a high degree of “reality” as these different virtual illumination conditions are based on measurement data. For example, the various scan operations may be performed with a different exposure intensity and/or with different colours, thereby providing the potential for calculating the various differences in brightness and colour of the virtual object on the basis of corresponding changes of the real object of the environment, such as the marker object, and any objects in the vicinity of the marker object.

Preferably, determining an illumination condition comprises identifying at least one light source illuminating the real environment and determining a position and/or an intensity and/or a colour of the at least one light source. For example, based on the scan data, the intensity and colour distribution and in particular “virtual” or real origins of light emission and the corresponding angles of incidence onto the real environment may be identified. For example, one or more light bulbs provided on a ceiling or corresponding room walls may readily be identified on the basis of the scan data and hence angles of incidence on the virtual object may be calculated by generating corresponding virtual light sources. Thus, corresponding virtual shadows and other brightness variations may be calculated on the basis of the virtual light sources. Moreover, the virtual light sources corresponding to the real illumination conditions may be varied, for instance upon user request, so as to provide the real environment including the virtual object with a changed illumination condition which may not represent the presently prevailing illumination condition in the real environment. Moreover, additional virtual light sources may be created, thereby enabling even the establishment of light conditions that may not be obtained by the real environment. For instance, the virtual objects themselves may represent light sources, such as illumination systems for rooms, houses, open air areas, such as gardens, parks, and the like, thereby allowing the investigation of the effect of different lighting systems on the real environment. Based on the scan data obtained from the real environment for one or more actual illumination conditions, the effect of the additional virtual light sources may be calculated highly efficiently so as to endow the virtual light source with a high degree of “reality”.

In a preferred embodiment, the virtual image data are displayed to the user with at least the marker object image data replaced by the object image data. Thus, the virtual image data including the virtual object may be displayed in any way as is appropriate for the specified application, thereby allowing for high flexibility in using the inventive augmented reality technique. For instance, when gathering image data of the real environment, for instance by camera operated by the user, the corresponding virtual reality including the virtual object may not necessarily be displayed appropriately on the camera due to a lack of appropriate display devices, whereas the virtual image data may be displayed, possibly after a corresponding image data manipulation and processing, on a suitable display. In some applications, the computational resources provided at the scene may not allow to provide a real-time operation of the system in the sense that the gathering of the image data of the real environment and the incorporation of the virtual object data is performed substantially simultaneously through, for instance, a highly complex data manipulation. In this case, the image data of the real environment may be appropriately segmented on the basis of appropriately selected time slots and the corresponding data manipulation for incorporating the virtual object may be performed on the basis of the segmented image data, which are then joined together and appropriately displayed, thereby imparting a certain delay with respect to the gathering of the image data. In the meantime, any further incoming image data of the real environment may be stored in a corresponding buffer. In this sense, the image data processing is in “real-time”, as any modification of the incoming image data is “simultaneously” seen in the virtual image data, however with an absolute time delay with respect to the actual event.

In a further preferred embodiment, the method comprises associating one or more sets of object data with one or more marker objects. Hence, suitable relationships between marker objects and corresponding virtual objects may be established, in advance, in real-time, or in any other desired configuration, thereby allowing a high degree of flexibility in using the augmented reality system. Thus, advantageously, after associating the one or more sets of object data with the one or more marker objects, a specific set of object data may be selected so as to replace a specific marker object that is associated with a plurality of sets of object data. Consequently, the virtual object may rapidly be exchanged upon selecting a different set of object data associated with the same marker object. The process of selecting a desired virtual object may be based on speech recognition, manual interaction of a user, software applications, and the like.

According to a further aspect, a method of forming a virtual mirror image comprises positioning a display means and an image capturing means in front of a part of interest of a real environment and gathering image data from the part of interest by operating the image capturing means. Moreover, a predefined marker object provided in the part of interest is identified on the basis of the image data and virtual image data are generated corresponding to the part of interest. Finally, at least virtual image data corresponding to the predefined marker object are replaced by object image data associated with a predefined marker object. Thus virtual images, for instance of a user, may be obtained, wherein the appearance of the user may be modified in accordance with any marker object attached to the user.

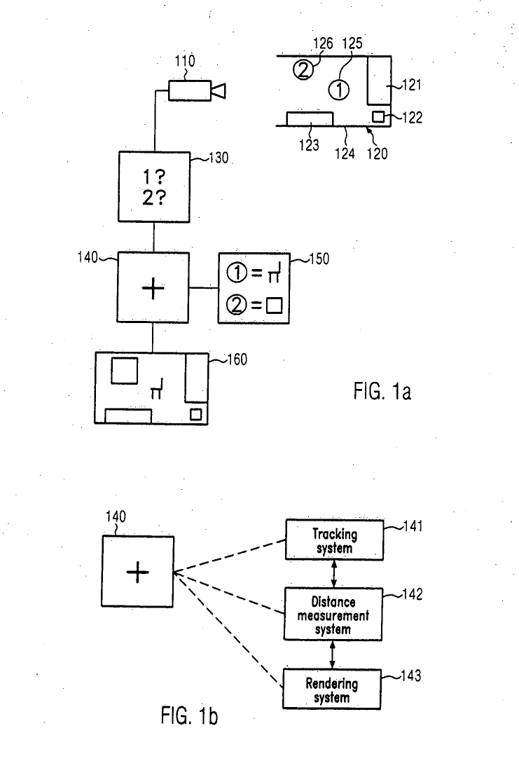

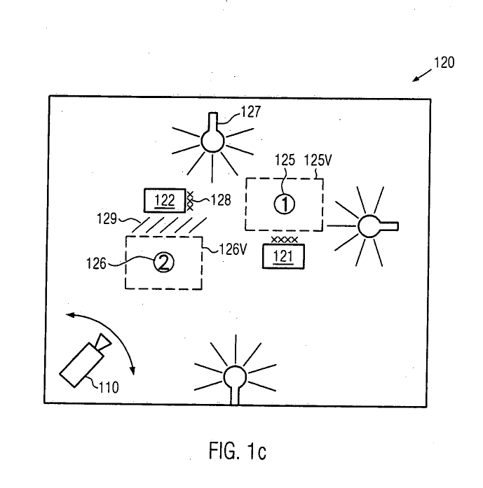

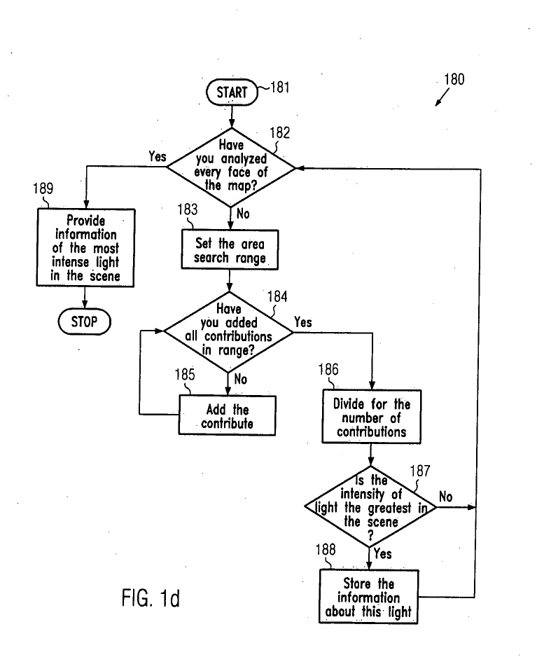

FIG. 1a schematically shows in a simplified illustration an augmented reality system 100 according to the present description. The system 100 comprises means 110 for gathering image data from a real environment 120. The means 110 may represent a video camera, a plurality of video cameras or any other appropriate image capturing devices, and the like. Moreover, the means 110 may also represent in some embodiments a source of image data that may have previously been obtained from the environment 120. Hereafter, the means 110 for gathering image data will be referred to as the camera 110, wherein it is not intended to restrict the present techniques to any particular optical imaging system. The real environment 120 may represent any appropriate area, such as a room of a house, a portion of a specific landscape, or any other scene of interest. In the representative embodiment shown in FIG. 1a, the real environment 120 represents, for instance, a living room comprising a plurality of real objects 121 . . . 124, for instance in the form of walls 124, and furniture 121, 122 and 123. Moreover, the real environment 120 may comprise further real objects that will be considered as marker objects 125, 126 which may have any appropriate configuration so as to be readily identified by automated image processing algorithms. For instance, the marker objects 125, 126 may have formed thereon significant patterns that may easily be identified, wherein the shape of the marker objects 125, 126 may be designed so as to allow an identification thereof from a plurality of different viewing angles. It should be appreciated, however, that the marker objects 125, 126 may also represent substantially two-dimensional configurations having formed thereon respective identification patterns. The system 100 further comprises a means 130 for identifying the marker objects 125, 126 on the basis of image data provided by the camera 110. The identifying means 130 may comprise well-known pattern recognition algorithms for comparing image data with predefined templates representing the marker objects 125, 126. For example, the identifying means 130 may have implemented therein an algorithm for converting an image obtained by the camera 110 into a black and white image on the basis of predefined illumination threshold values. The algorithm may further be configured to divide the image into predefined segments, such as squares, and to search for pre-trained pattern templates in each of the segments, wherein the templates may represent significant portions of the marker objects 125, 126. However, any other pattern recognition techniques may be implemented in the identifying means 130.

In one illustrative embodiment, first the live video image is turned into a black and white image based on a lighting threshold value. This image is then searched for square regions. The software finds all the squares in the binary image, many of which are not the tracking

markers, such as the objects 125, 126. For each square, the pattern inside the square is matched against some pre-trained pattern templates. If there is a match, then the software has found one of the tracking markers, such as the objects 125, 126. The software may then use the known square size and pattern orientation to calculate the position of the real video camera relative to the physical marker such as the objects 125, 126. Then, a 3×4 matrix is filled with the video camera's real world coordinates relative to the identified marker. This matrix is then used to set the position of the virtual camera coordinates. Since the virtual and real camera coordinates are the same, the computer graphics that are drawn precisely superimpose the real marker object at the specified position. Thereafter, a rendering engine may be used for setting the virtual camera coordinates and drawing the virtual images.

The system 100 further comprises means 140 for combining the image data received from the camera 110 with object data obtained from an object data generator 150. The combining means 140 may comprise a tracking system, a distance measurement system and a rendering system, as is described in more detail with reference to FIG. 1b. Generally, the combining means 140 is configured to incorporate image data obtained from the generator 150 for a correspondingly identified marker object so as to create virtual image data representing a three-dimensional image of the environment 120 with additional virtual objects corresponding to the marker objects 125, 126. Hereby, the combining means 140 is configured to determine the respective positions of the marker objects 125, 126 within the real environment 120 and also to track a relative motion between the marker objects 125, 126 with respect to any static objects in the environment 120 and with respect to a point of view defined by the camera 110.

The system 100 may further comprise output means 160 configured to provide the virtual image data, including the virtual objects generated by the generator 150 wherein, in preferred embodiments, the output means 160 is also configured to provide, in addition to image data, other types of data, such as audio data, olfactory data, tactile data, and the like.

In operation, the camera 110 creates image data of the environment 120, wherein preferably the image data may correspond to a dynamic state of the environment 120 which may, for instance, be represented by merely moving the camera 110 with respect to the environment 120, or by providing moveable objects within the environment, for instance the marker objects 125, 126, or one or more of the objects 121 . . . 123 may be moveable. For example, the point of view of the environment 120 may be changed by moving around the camera 110 within the environment 120, thereby allowing to observe especially the marker objects 125, 126 from different perspectives so as to enable the assessment of virtual objects created by the generator 150 from different points of view. The image data provided by the camera 110 which may continuously be updated, are received by the identifying means 130, which recognizes the marker objects 125, 126 and enables the tracking of the marker objects 125, 126 once they are identified, even if pattern recognition is hampered by continuously changing the point of view by, for instance, moving the camera 110 or the marker objects 125, 126. For example, after identifying a predefined pattern associated with the marker objects 125, 126 within the image data, the identifying means 130 may inform the combining means 140 about the presence of a marker object within a specified image data area and based on this information, the means 140 may then continuously track the corresponding object represented by the image data used for identifying the marker objects 125, 126, assuming that the marker objects 125, 126 will not vanish over time. In other embodiments, the process of identifying the marker objects 125, 126 may be performed substantially continuously or at least may be repeated on a regular basis so as to confirm the presence of the marker objects 125, 126 and also to verify or enhance the tracking accuracy of the combining means 140. Based on the image data of the environment and the information provided by the identifying means 130, the combining means 140 creates three-dimensional image data and superimposes corresponding three-dimensional image data received from the object generator 150, wherein the three-dimensional object data are permanently updated on the basis of the tracking operation of the means 140. For instance, the means 140 may, based on the information of the identifying means 130, calculate the position of the camera 110 with respect to the marker objects 125, 126 and use this coordinate information for determining the coordinates of a virtual camera, thereby allowing a precise “overlay” of the object data delivered by the generator 150 with the image data of the marker objects 125, 126. The coordinate information also includes data on the relative orientation of the marker objects 125, 126 with respect to the camera 110, thereby enabling the combining means 140 to correctly adapt the orientation of the virtual object. Finally, the combined three-dimensional virtual image data may be presented by the output means 160 in any appropriate form. For example, the output means 160 may comprise appropriate display means so as to visualize the environment 120 including virtual objects associated with the marker objects 125, 126. When operating the system 100 it is advantageous to pre-install recognition criteria for at least one marker object 125, 126 so as to allow a substantially reliable real-time image processing. Moreover, the correlation between a respective marker object and one or more virtual objects may be established prior to the operation of the system 100 or may also be designed so as to allow an interactive definition of an assignment of virtual objects to marker objects. For example, upon user request, virtual objects initially assigned to the marker object 125 may be assigned to the marker object 126 and vice versa. Moreover, a plurality of virtual objects may be assigned to a single marker object and a respective one of the plurality of virtual objects may be selected by the user, by a software application, and the like.

FIG. 1b schematically shows the combining means 140 in more detail. In this embodiment, the combining means 140 comprises a tracking system 141, a distance measurement system 142 and a rendering system 143. As previously explained, the tracking system 141 is configured to track the relative position and orientation of the marker objects 125, 126, thereby enabling the adaptation of the object data provided by the generator 150. However, since initially in many applications the absolute dimensions encountered in the environment 120 may not be known, an accurate adaptation of the virtual object to the environment 120 may require an absolute reference distance to be identified in the real environment 120. For this purpose, the distance measurement system 142 is connected to the tracking system 141 and is adapted to determine at least one absolute measure, for instance in the form of the distance between two readily identifiable objects or portions thereof within the environment 120. The distance measurement system 142 may comprise any appropriate hardware and software resources, such as interferometric measurement tools, ultrasound measurement devices, and the like, so as to allow to determine an absolute measure of some elements in the environment 120. The distance measurement system 142 may be controlled by the tracking system 141 so as to determine an absolute measure of an element within the environment 120, which may also be recognized by the tracking system, thereby allowing to assign the absolute measurement result to the respective image data representing the specified element. In one illustrative embodiment, one or more of the marker objects 125, 126 may be used as reference elements for determining an absolute distance therebetween, since the marker objects 125, 126 are readily identified by the identifying means 130. In other embodiments, the distance measurement system 142 may be obsolete and corresponding information for correctly scaling the virtual objects may be input by the user.

The combining means 140 further comprises the rendering system 143 for generating the three-dimensional virtual image data on the basis of the image data obtained from the camera 110 and the data of the object generator 150. Moreover, the rendering system 143 is further configured to determine the illumination condition in the environment 120 and to correspondingly adapt the “virtual” illumination condition of the three-dimensional image data provided by the output means 160. For this purpose, the rendering system 143 may determine the actually prevailing illumination condition in the environment 120, for instance by appropriately scanning the environment 120 so as to establish an illumination map and identify real light sources.

FIG. 1c schematically shows the environment 120 including the marker objects 125, 126 at predefined positions as well as real objects 121, 122, wherein a plurality of real light sources 127 may provide for a specific illumination condition within the environment 120. In this situation, the rendering system 143 may receive scan data from the camera 110, which may be moved so as to allow the determination of at least some of the characteristics of the light sources 127. For example, the camera 110, depending on its relative position, may be moved so as to cover a large portion of the solid angle corresponding to the environment 120. Based on the scan data, the rendering system 143 may then determine the position and the intensity and possibly the colour distribution of the various light sources 127.

FIG. 1d depicts a schematic flow chart 180 that illustrates an exemplary process flow performed by the rendering system 143 for obtaining information on the illumination conditions of the environment 120.

In step 181 the process flow is initiated, for instance upon request by the user and/or by software, which may consider excessive camera motion as a scan activity, or which may decide to perform an assessment of the current illumination conditions any other criteria. In step 182 the image data obtained from the camera 110, organized as an illumination map including an appropriate number of sections, is assessed whether all of the sections have been analysed so far. If all the sections are analysed, the process flow may advance to step 189, in which information on the most intensive light, i.e. in FIG. 1c the light sources 127, in the scene is provided for further data processing. If not all of the sections are analysed, the process flow advances to step 183, in which the sections are set as suitable area search ranges for detecting light sources. Then in step 184 it is assessed whether all contributions for estimating the light intensity and other light-specific characteristic are added for the section under consideration. If not all contributions are taken into consideration, in step 185 all of the contributions are added up and the process flow returns to step 184. If in step 184 all contributions are taken into consideration, the process flow advances to step 186, in which the intensity of the section under consideration is estimated by, for instance, assessing the number of contributions and, if they differ in value, their respective magnitude. Thereafter, in step 187 the intensity of the section under consideration is compared with the currently highest intensity so as to identify the currently greatest intensity value of the scene. If in step 187, the section under consideration is assessed as not having the highest intensity of the scene currently processed, the process flow returns to step 182. When the intensity of the section under consideration is considered highest for the currently processed scene, the process advances to step 188, in which relevant information about this section is stored and may be provided in step 189 after all of the sections are analysed.

Again referring to FIG. 1c, based on the position data and intensity of the light sources 127 identified in the environment 120, for instance by the process flow 180, the rendering system 143 may determine corresponding virtual light sources for the virtual three-dimensional image space so as to simulate the illumination condition in the environment 120. The rendering system 143 may then calculate the effect of the virtual light sources on the environment 120, when the virtual objects corresponding to the marker objects 125, 126, indicated in dashed lines in FIG. 1c, are incorporated into the environment 120. As may be seen from FIG. 1c, the real environment 120 may substantially be free of any shadows due to the specific configuration of the light sources 127. However, after “inserting” the virtual objects 125v and 126v, virtual shadows and brightness variations may be created as the virtual light distribution may be affected by the virtual objects 125v, 126v. For example, the virtual object 125v may cause an area of reduced brightness 128 on the real object 122 caused by blocking the light of the respective light source. Similarly, the real object 122 may now create a virtual shadow 129 due to the presence of the object 126v and 125v. Thus, the rendering system 143 may correspondingly adapt the appearance of the virtual objects 126v, 125v as well as the appearance of the real objects 122, 121 in accordance with the virtual light sources created on the basis of the scan data and thus the real illumination conditions.

In some embodiments, the real illumination conditions may be altered, for instance by varying the light exposure of any light sources, so as to establish corresponding illumination maps for different illumination conditions. Thus, corresponding virtual light sources may be created that correspond to the various real illumination conditions. Moreover, the rendering system 143 may further be configured to provide additional virtual light sources and virtual illumination conditions so as to establish any illumination conditions that may not be deduced from the scan data. For example, the virtual objects may represent highly reflective objects or may themselves represent light sources, which may then provide for illumination conditions in the environment 120 that are not deducible from scan data.

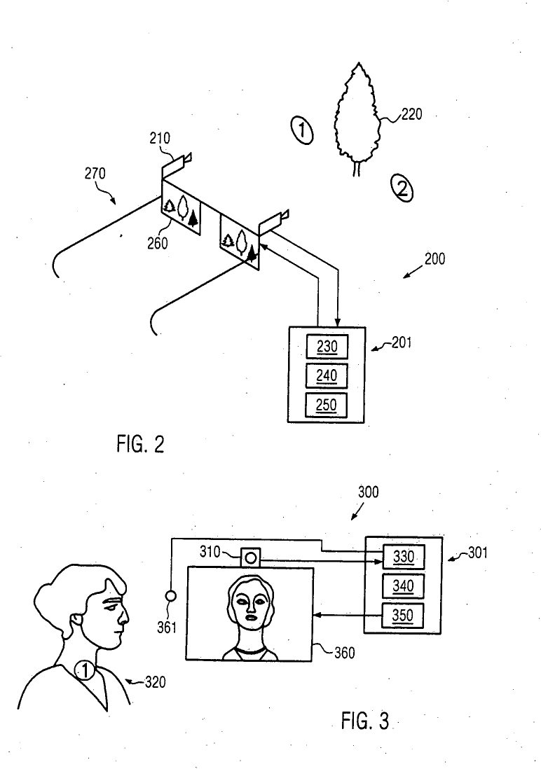

FIG. 2 schematically shows a further embodiment of the augmented reality system according to the present description. In this embodiment, a system 200 comprises a data manipulation section 201 including, for instance, a marker object identifying means 230, a combining means 240 and the virtual object generator 250, which may have a similar configuration as is also described with reference to FIGS. 1a-1c. In particular, the combining means 240 may include a tracking system and a rendering system, such as the corresponding systems 141 and 143. Connected to the data manipulation system 201 is a head-mounted display device 270, which comprises display surfaces 260 and which also comprises an optical imaging system 210 that may be provided in the form of two appropriately positioned cameras. Moreover, a real environment 220 is provided including respective marker objects.

The operation of the system 200 is similar to that of the system 100, wherein, however, the data manipulation system 201 is configured to process image data substantially in real-time without significant time delay. In this case, a user wearing the head-mounted device 270 may obtain a highly accurate impression of the real environment 220, which is correspondingly supplemented by virtual objects associated with the respective marker objects. Advantageously, the cameras 210 may be positioned so as to substantially correspond to the user's eyes, that is, the cameras 210 may, contrary to how it is shown, be positioned within the display surfaces 260, since the display surfaces 260 are not required to transmit light from the environment 220. Consequently, a highly three-dimensional virtual image of the environment 220 may be established, thereby increasing the “reality” of the virtual image obtained from the environment 220 and the corresponding virtual objects. Moreover, the head-mounted device 270 may comprise a distance measurement system, thereby allowing a precise scaling of any virtual objects with respect to the real objects in the environment 220.

FIG. 3 schematically shows a virtual mirror system 300 including a data manipulation system 301 which may comprise a marker identification means 330, an image data combining means 340a and a virtual object generator 350. The corresponding components of the data manipulation system 301 may be configured similarly to those previously described with reference to the components of the system 100 and 200. Moreover, the system 300 comprises an output means 360 comprising a display surface that is positioned in front of a part of interest of a real environment 320. Moreover, the system 300 comprises an optical imaging system 310 that is also positioned in front of the interesting part of the environment 320 so that a virtual “mirror” image may be displayed on the display surface 360 upon operation of the system 300. In principle, the operation of the system 300 is similar to the operation of the system 100 and 200. That is, after gathering image data by the optical imaging system 310, a marker object is identified, for instance attached to a user positioned so as to face the optical imaging system 310 and the display surface 360, and the marker object is identified and tracked, as is previously described. Moreover, based on a predefined or user-initiated association of one or more marker objects with respective virtual objects, the generator 350 provides corresponding object data to the combining means 340, which may produce corresponding virtual image data including the virtual object. The corresponding virtual image data are then provided to the output means 360 so as to give the user the impression of a mirror image. Moreover, further input or output means 361 may be provided, for instance in the form of a loudspeaker, a microphone, and the like, so as to enhance the output capabilities of the system 300 and/or provide enhanced input capabilities. For instance, a speech recognition system may be implemented within the means 361 so as to allow the user to control the data manipulation system 301, for instance for the selection of specific virtual objects that should replace the marker object in the virtual image. Moreover, the system 300, ie. the marker identification means 330, may be configured so as to recognize a plurality of marker objects substantially simultaneously so as to allow the presence of a plurality of virtual objects in the virtual image. For example, jewellery, clothes, and the like, may be used as virtual objects sequentially or simultaneously. Moreover, the combining means 340 may comprise a rendering system, similar to the system 143, enabling an appropriate adaptation of illumination conditions so as to provide the virtual mirror image under various real or virtual light conditions, which may be highly advantageous in applications, such as assessing jewellery, clothes, cosmetic or surgical operations, and the like.

1. An augmented reality system comprising:
means for gathering image data of a real environment;
means for generating virtual image data from said image data;
means for identifying a predefined marker object of said real environment based on said image data;and
means for superimposing a set of object image data with said virtual image data at a virtual image position corresponding to said predefined marker object.

2. The augmented reality system of claim 1, further comprising means for correlating a plurality of sets of object image data with said predefined marker object.

3. The augmented reality system of claim 2, further comprising means for selecting one of the plurality of sets of object image data to be superimposed with said virtual image data.

4. The augmented reality system of claim 3 wherein said means for selecting one of the plurality of sets of object image data comprises a speech recognition system.

5. The augmented reality system of claim 3 wherein said means for selecting one of the plurality of sets of object image data comprises manual input means.

6. The augmented reality system of claim 1, further comprising output means for displaying at least said virtual image data.

7. The augmented reality system of claim 6 wherein said output means comprises a head mounted display means.

8. The augmented reality system of claim 7 wherein said head mounted display means comprises said means for gathering image data of a real environment.

9. The augmented reality system of claim 1 wherein said means for identifying a predefined marker object comprises a tracking system configured to determine relative position data and orientation data with respect to said means for gathering image data of a real environment.

10. The augmented reality system of claim 9 wherein said tracking system is configured to provide said relative position data and orientation data substantially in real time.

11. The augmented reality system of claim 1, further comprising an object data generator for obtaining said set of object image data.

12. The augmented reality system of claim 1, further comprising a rendering system configured to operate on said set of object image data and said virtual image data to adapt said object image data to illumination conditions represented by said virtual image data.

13. The augmented reality system of claim 12 wherein said rendering system is further configured to generate virtual shadow on the basis of the position of said marker object, said set of object image data and said illumination conditions.

14. The augmented reality system of claim 13, further comprising a virtual illumination system configured to determine at least a position and/or an intensity and/or a colour distribution of at least one real light source from said image data.

15. The augmented reality system of claim 14 wherein said virtual illumination system is further configured to generate a virtual light source corresponding to said at least one real light source.

16. The augmented reality system of claim 15 wherein said virtual illumination system is configured to vary at least one of a position, an intensity and a colour distribution of said virtual light source.

17. The augmented reality system of claim 15 wherein said virtual illumination system is further configured to generate a second virtual light source in addition to said virtual light source corresponding to said at least one real light source.

18. A virtual mirror system comprising:
an augmented reality system configured according to claim 1, and
a display means having a display surface positioned in front of a part of interest of said real environment,
wherein said means for gathering image data of said real environment comprises an optical imaging system positioned in front of said part of interest.

19. The virtual mirror system of claim 18 wherein said means for identifying a predefined marker object is configured to identify a plurality of predefined marker objects provided in said part of interest.

20. A method of generating an augmented reality, comprising:
gathering image data from a real environment,
identifying a predefined marker object provided in said real environment on the basis of said image data,
generating virtual image data of said real environment, and
replacing at least virtual image data corresponding to said predefined marker object by object image data associated with said predefined marker object.

21. The method of claim 20, further comprising tracking said predefined marker object when modified image data, indicating a relative displacement of the marker object, are gathered from said real environment.

22. The method of claim 21 wherein tracking said predefined marker object at least comprises determining a relative position and orientation of said predefined marker object with respect to a virtual reference point.

23. The method of claim 20, further comprising generating said object image data on the basis of image data from a second real environment that is different from said real environment.

24. The method of claim 20, further comprising generating said object image data on the basis of said image data from said real environment.

25. The method of claim 20, further comprising generating said object image data on the basis of a virtual reality.

26. The method of claim 20, further comprising scanning at least a portion of said real environment to generate scan data and determining an illumination condition of said real environment on the basis of said scan data.

27. The method of claim 26 wherein scanning said portion of said real environment is performed for at least two different illumination conditions.

28. The method of claim 26 wherein determining an illumination condition comprises identifying at least one light source illuminating said real environment and determining a position and/or an intensity and/or a colour of said at least one light source.

29. The method of claim 28, further comprising generating a virtual illumination condition on the basis of said at least one identified light source.

30. The method of claim 29 wherein generating said virtual illumination condition comprises generating virtual shadow caused by said object image data and/or caused by said virtual image data corresponding to said real environment.

31. The method of claim 29 wherein generating said virtual illumination condition comprises virtually varying at least one of the position, the intensity and the colour of said at least one light source.

32. The method of claim 20, further comprising generating at least one virtual light source, said at least one virtual light source having no corresponding light source in said real environment.

33. The method of claim 20, further comprising displaying said virtual image data with at least said marker object image data replaced by said object image data.

34. The method of claim 20, further comprising associating one or more sets of object data with one or more marker objects.

35. The method of claim 34, further comprising selecting a specific set of object data for replacing said virtual image data corresponding to specific marker object that is associated with a plurality of sets of object data.

36. The method of claim 35 wherein selecting said specific set of object data comprises recognizing speech data and determining whether said recognised speech data correspond to one of the plurality of sets of object data.

37. A method of forming a virtual mirror image, comprising:
positioning a display means and an image capturing means in front of a part of interest of a real environment,
gathering image data from said part of interest by said image capturing means,
identifying a predefined marker object provided in said part of interest on the basis of said image data,
generating virtual image data of said part of interest, and
replacing at least virtual image data corresponding to said predefined marker object by object image data associated with said predefined marker object.

38. The method of claim 37 wherein said part of interest includes at least a portion of a user having attached said predefined marker object.

39. The method of claim 38 wherein said object image data represent clothes.

40. The method of claim 37 wherein a second predefined marker object is provided that is associated with second object image data.
